(19) United States
(12) Patent Application Publication
(10) Pub. No.: US 2007/0242573 A1
(43) Pub. Date: Oct. 18, 2007

(54) Optical system driving device

(75) Inventors: Hikaru Nagasawa, Tokyo (JP); Hiroshi Aso, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Opto, Inc., Tokyo (JP)

(21) Appl. No.: 11/786,533

(22) Filed: Apr. 12, 2007

(30) Foreign Application Priority Data
Apr. 13, 2006 (JP) 2006-110829

(51) Int. Cl. G11B 7/00

(52) U.S. Cl. 369/44.15

(57) ABSTRACT

An optical system driving device, includes: a carriage on which an objective lens is mounted; a guide for slidably supporting the carriage to guide the carriage in a tracking direction; at least a pair of coils which are attached to both sides of the carriage and which are wound in a direction perpendicular to a plane including the tracking direction and an optical axis of the objective lens; and at least a pair of magnet sections which are opposed to the coils so as to sandwich the carriage, wherein each of the pair of magnet sections has a permanent magnet in which two magnetic poles are arranged in a direction perpendicular to the plane including the tracking direction and the optical axis of the objective lens, and the two magnetic poles of one permanent magnet are arranged in an opposite direction of the two poles of the other permanent magnet.

### BACKGROUND OF THE INVENTION

1. Field of the Invention

The present invention relates to an optical system driving device. In particular, the present invention relates to an optical system driving device mounted to a pickup apparatus for reading CD, DVD or the like.

2. Description of Related Art

An optical system driving device mounted to a pickup apparatus is arranged to move an objective lens in a tracking direction by using electromagnetic power (see for example Japanese Patent Laid-Open Publication No. 8-87765). Specifically, as shown in FIG. 4, an optical system driving device 100 includes an objective lens 101 and a carriage 102 on which the objective lens 101 is mounted. The carriage 102 is slidably supported by a pair of guides 103. The guide 103 is provided along the tracking direction. When the carriage 102 is slid along the guide 103, the objective lens 101 is moved along the tracking direction.

Coils 104 are fixed at both side faces of the carriage 102 so that the winding direction of the coils are along the tracking direction. An inner yoke 105 is inserted into the coil 104 in parallel with the guide 103. At an exterior of the inner yoke 105, an outer yoke 106 is provided so that the outer yoke 106 and the inner yoke 105 form a frame. At an interior of the outer yoke 106, a bar permanent magnet 107 is provided along the inner yoke 105.

When current flows in the coil 104, electromagnetic power is generated between the coil 104 and the permanent magnet 107. The electromagnetic power causes the carriage 102 to move along the guide 103, and the objective lens 101 is moved in the tracking direction. When current flowing in the coil is controlled, a position control of the objective lens 101 is performed.

Due to the above structure, during the movement, the coil 104 itself easily resonates. When the resonant is caused, the position control of the objective lens becomes unstable.

### SUMMARY OF THE INVENTION

The present invention has been made in view of the above problem. An object of the present invention is to suppress the resonance of the coil and to improve the accuracy of the position control of the objective lens.

According to one aspect of the present invention, an optical system driving device, comprises:

a carriage on which an objective lens is mounted;

a guide for slidably supporting the carriage to guide the carriage in a tracking direction;

at least a pair of coils which are attached to both sides of the carriage and which are wound in a direction perpendicular to a plane including the tracking direction and an optical axis of the objective lens; and

at least a pair of magnet sections which are opposed to the coils so as to sandwich the carriage,

wherein each of the pair of magnet sections has a permanent magnet in which two magnetic poles are arranged in a direction perpendicular to the plane including the tracking direction and the optical axis of the objective lens, and

the two magnetic poles of one permanent magnet are arranged in an opposite direction of the two poles of the other permanent magnet.

Preferably, the optical system driving device further comprises:

a frame for retaining the permanent magnets and the guide;

a frame guide for slidably supporting the frame to guide the frame in the tracking direction; and

a transfer mechanism engaged with the frame to transfer the frame in the tracking direction.

### BRIEF DESCRIPTION OF THE DRAWINGS

The present invention will become more fully understood from the detailed description and the accompanying drawings given hereinafter, which are for illustration purpose only, and thus are not intended to limit of the scope of the present invention, and wherein:

FIG. 1 is a perspective view for schematically illustrating the structure of an optical system driving device of this embodiment;

FIG. 2 is a perspective view for schematically illustrating the structure of the first transfer mechanism provided in the optical system driving device of FIG. 1;

FIG. 3 illustrates a positional relation between a coil provided in the first transfer mechanism of FIG. 2 and a permanent magnet; and

FIG. 4 is a perspective view for schematically illustrating the structure of a conventional optical system driving device.

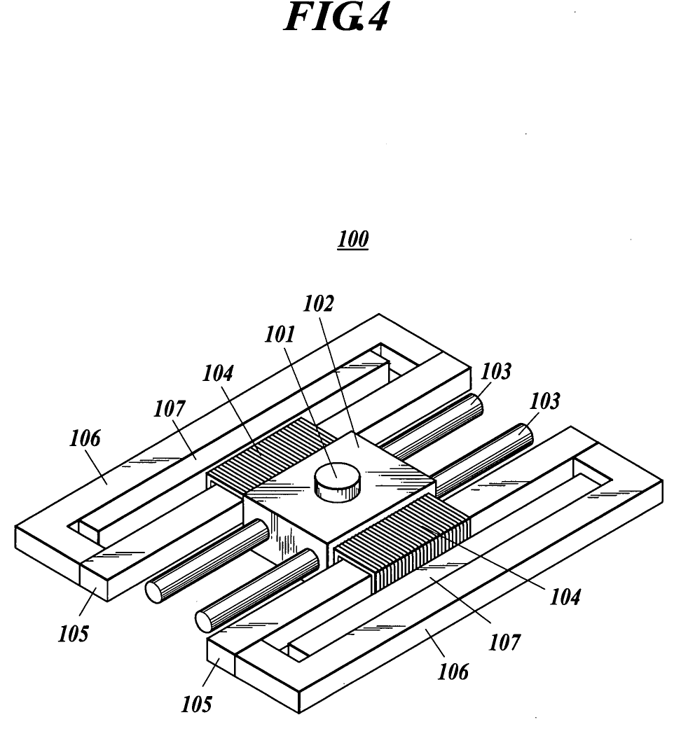

### PREFERRED EMBODIMENT OF THE INVENTION

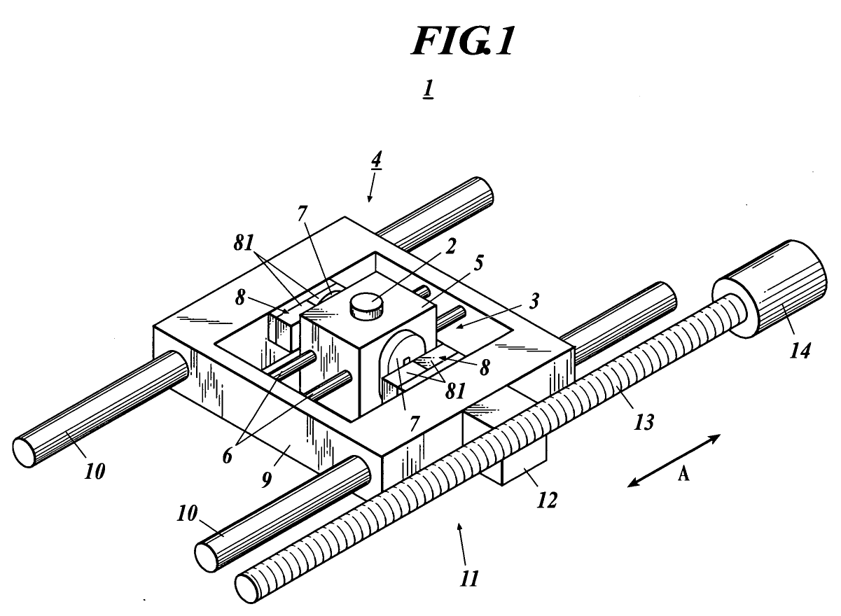

Hereinafter, an optical system driving device in this embodiment will be described with reference to the drawings. FIG. 1 is a perspective view for schematically illustrating the structure of an optical system driving device 1 of this embodiment. As shown in FIG. 1, the optical system driving device 1 comprises: the first transfer mechanism 3 for finely adjusting the position of an objective lens 2; the second transfer mechanism 4 for moving the objective lens 2 in the entire travel range in the tracking direction A prior to the fine adjustment by the first transfer mechanism 3; and a control section (not shown) for controlling the first transfer mechanism 3 and the second transfer mechanism 4.

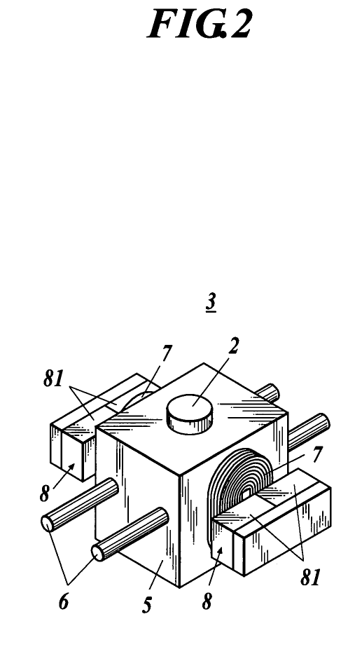

FIG. 2 is a perspective view for schematically illustrating the structure of the first transfer mechanism 3. As shown in FIG. 2, the first transfer mechanism 3 comprises: a carriage 5 on which the objective lens 2 is mounted; a pair of guides 6 that slidably support the carriage 5 to guide the carriage 5 in the tracking direction A; a pair of coils 7 attached to both sides of the carriage 5; and a pair of magnet sections 8 that are opposed to the coils 7 so as to sandwich the carriage 5.

In this embodiment, the coil 7 is previously wound to have a predetermined size and the wound coil 7 is fixed to the carriage 5. When the carriage 5 has a boss and the coil 7 is attached to the boss, the coil 7 can be accurately positioned.

On the contrary, when the coil 7 is wound around the boss of the carriage 5, the carriage 5 and the coil 7 are used as a single member in which the carriage 5 is integrated with the coil 7, in the assembly steps. Thus, the number of the assembly steps can be reduced.

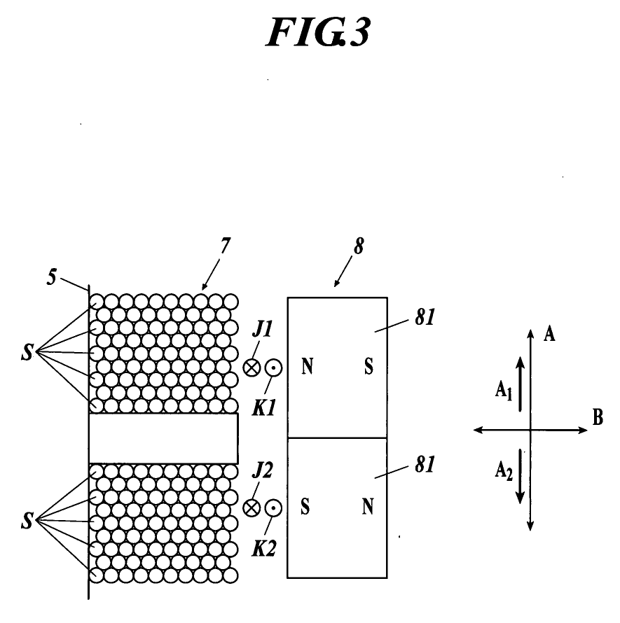

FIG. 3 illustrates a positional relation between the coil 7 and the magnet section 8. As shown in FIG. 3, a pair of magnet sections 8 comprises at least a pair of permanent magnets 81 in which two magnetic poles are arranged in a direction B perpendicular to the tracking direction A (the direction B is perpendicular to a plane including the tracking direction A and an optical axis of the objective lens 2.). The pair of permanent magnets 81 are placed so that two poles of one permanent magnet are arranged in an opposite direction of two poles of the other permanent magnet. The coil 7 is also wound along the direction B perpendicular to the tracking direction A. By winding the coil 7 in the manner as described above, a wire S which is wound so as to form a plurality of layers at the base of the coil 7 is fixed to the carriage 5.

When current flows in the coil 7, electromagnetic power is generated in the coil 7 to move the coil 7 in the tracking direction A. Specifically, when current flows in an upper part of the coil 7 in a direction from the front side to the rear side (direction J1) and current flows in a lower part of the coil 7 in a direction from the rear side to the front side (direction J2), the coil 7 is moved in the tracking direction A1. When current flows in the upper part of the coil 7 in a direction from the rear side to the front side (direction K1) and current flows in the lower part of the coil 7 in a direction from the front side to the rear side (direction K2), the coil 7 is moved in the tracking direction A2. By the movement, the carriage 5 is moved along the guide 6. Therefore, it is possible to carry out the position control of the objective lens 2.

As shown in FIG. 1, the second transfer mechanism 4 comprises a frame 9 for retaining a magnet section 8 and a guide 6 of the first transfer mechanism 3; a frame guide 10 for slidably supporting the frame 9 to guide the frame 9 in the tracking direction A; and a sending mechanism 11 that is engaged with the frame 9 to move the frame 9 in the tracking direction A.

In the sending mechanism 11, a link section 12 in which a plurality of teeth (not shown) are formed along the tracking direction A, is provided so as to be fixed to one side of the frame 9. The sending mechanism 11 comprises a lead screw 13 that is provided in the tracking direction A and that is engaged with the teeth of the link section 12; and a motor 14 for rotating the lead screw 13. When the motor 14 rotates the lead screw 13, the frame 9 is moved via the link section 12 in the tracking direction A. The lead screw 13 has a length that is at least equal to or longer than the travel range of the objective lens 2. Therefore, the frame 9 can move within the travel range of the objective lens 2 in the tracking direction A along the frame guide 10. It is possible to carry out the position control of the objective lens 2.

Electromagnetic power is generated only in a range of the size of the coil 7. Thus, in order to supply electromagnetic power to the entire travel range, the coil 7 must be sized to cover the travel range. Such a large-sized coil 7 is not desirable because much material of the coil is required and an increased weight of a movable portion, an increased resistance value, and a deteriorated strength for example, are caused. In the structure of the optical device, the entire travel range is managed by another sending mechanism and the section in which the high accuracy and high responsiveness are required at the final stage is managed by electromagnetic power.

Although the sending mechanism 11 is described as a mechanism using a lead screw, a mechanism in which the objective lens can be moved at a high speed, may be applied to the sending mechanism. For example, a transfer mechanism other than a stepping motor, e.g., the so-called SIDM® using a piezoelectric element, an ultrasonic motor, or shape memory alloy or the like can be applied. By the sending mechanism, the objective lens is roughly moved, and the high accurate movement control is not required. Thus, the mechanism having a simple movement control function can be applied to the sending mechanism.

Next, an operation of this embodiment will be described.

During the position control of the objective lens 2, the control section firstly controls the second transfer mechanism 4 to move the objective lens 2. At the same time, the control section controls the motor 14 to rotate the lead screw 13 and to move the frame 9 in the tracking direction A. Thereafter, the control section stops the motor 14 so that the frame 9 stops in the vicinity of a predetermined tracking position. The movement of the objective lens 2 by the second transfer mechanism 4 is finished.

Thereafter, the control section controls the first transfer mechanism 3 to move the objective lens 2. At the same time, the predetermined current flows in the coil 7. As a result, electromagnetic power is applied between the coil 7 and the magnet section 8. By the electromagnetic power, the carriage 5 is moved along the guide 6 in the tracking direction A. Thereafter, by the control section, the current flows in the coil 7 so that the objective lens 2 tracks a predetermined position on a disk to perform the movement of the objective lens 2 by the first transfer mechanism 3.

As described above, according to this embodiment, the coils 7 wound in the direction B perpendicular to the tracking direction A are attached to both sides of the carriage 5. Thus, the direction along which the coil 7 is wound is perpendicular to the tracking direction A. By attaching the coil 7 to the carriage 5 in this manner, the wire S which is wound so as to form a plurality of layers at the base of the coil 7 is fixed to the carriage 5. Thus, it is difficult to deflect the coil 7 and the strength of the coil 7 is increased. Because the ratio of the fixing area for the coil 7 to the entire coil 7 is increased and the strength thereof is increased as described above, the resonance of the coil 7 can be suppressed. Therefore, the stability of the coil 7 is easily maintained. Further, the position control of the objective lens 2 can be performed with a higher accuracy.

Furthermore, because the frame 9 is moved in the tracking direction A by the sending mechanism 11 of the second transfer mechanism 4, the tracking position of the objective lens 2 is roughly adjusted. After this position adjustment of the second transfer mechanism 4, the carriage 5 is moved in the tracking direction the electromagnetic power between the coil 7 of the first transfer mechanism 3 and the magnet section 8. Therefore, the tracking position of the objective lens is finely adjusted.

As described above, an embodiment of the present invention has been described. However, the present invention should not be construed so as to limit the present invention to the above embodiment and also may be appropriately changed or modified. For example, the above-described embodiment also may be arbitrarily combined with a modified example.

The entire disclosure of a Japanese Patent Application No. 2006-110829 filed on Apr. 13, 2006, including specification, claims, drawings and summary are incorporated herein by reference in their entirety.

What is claimed is:

1. An optical system driving device, comprising:
a carriage on which an objective lens is mounted;
a guide for slidably supporting the carriage to guide the carriage in a tracking direction;
at least a pair of coils which are attached to both sides of the carriage and which are wound in a direction perpendicular to a plane including the tracking direction and an optical axis of the objective lens; and
at least a pair of magnet sections which are opposed to the coils so as to sandwich the carriage,
wherein each of the pair of magnet sections has a permanent magnet in which two magnetic poles are arranged in a direction perpendicular to the plane including the tracking direction and the optical axis of the objective lens, and
the two magnetic poles of one permanent magnet are arranged in an opposite direction of the two poles of the other permanent magnet.

2. The optical system driving device of claim 1, further comprising:
a frame for retaining the permanent magnets and the guide;
a frame guide for slidably supporting the frame to guide the frame in the tracking direction; and
a transfer mechanism engaged with the frame to transfer the frame in the tracking direction.
